(19) United States
(12) Patent Application Publication
(10) Pub. No.: US 2003/0141984 A1
(43) Pub. Date: Jul. 31, 2003

(54) Method to expedite home delivery service

(76) Inventors: John Sarek JR., Canon City, CO (US); Steven M. Cornella, Canon City, CO (US); Joe E. Cornella, Florence, CO (US)

Correspondence Address: Glen F. Gallinger, 7420 Milner Dr., #1000, Colorado Springs, CO, 80920, US

(21) Appl. No.: 10/059,660

(22) Filed: Jan. 28, 2002

(51) Int. Cl. G08B 5/00

(52) U.S. Cl. 340/815.4; 340/691.1; 340/994; 340/539.1; 40/584; 40/124.01; 40/541

(57) ABSTRACT

Efficient and timely deliveries to residential customers are good business. Hot pizza generates tips. Cold pizza, a result of a time consuming search for the residential customer is time consuming, expensive and frustrating for delivery personnel. A method of expediting delivery service to residence target locations comprises the steps of: providing an illuminated sign having a delivering service company's indicia thereon; and, positioning the illuminated sign on an interior side of a front window glass at one of the target delivery locations. A preferred aspect of this method further comprises the step of providing a remotely controlled activator and alarm within the illuminated sign so that the illuminated sign would additionally flash and sound an alarm when the remotely controlled activator was activated by delivery personnel entering the proximate area of the sign. The flashing would make the sign more recognizable to delivery personnel, and the alarm would indicate to the recipients that a delivery was imminent.

### FIELD OF THE INVENTION

This invention relates to service industries having deliveries made to consumer residences. More particularly this invention relates to a method utilizing an illuminated sign to expedite home delivery services.

### BACKGROUND OF THE INVENTION

The applicants are familiar the problems encountered in delivering services to individuals in their homes. During daylight frequently there are no visible house numbers. In the evening and night there are far fewer visible house numbers. Much time can be consumed approaching homes with a flashlight in hopes of identifying a particular house number. Most of us can recollect occasions when we were delayed while locating a residence in an unfamiliar subdivision. House street numbers, and even streets are not always continuous.

The problems encountered in making deliveries to homes are exacerbated for pizza delivery personnel. Pizza deliveries are most frequently made in the evening. Pizza deliveries must be made in all types of weather. Inefficiently made deliveries greatly raise a delivery driver's costs. Pizza delivery drivers normally receive a substantial portion of their income as tips. Tips are dependent on quick and timely delivery of hot pizza. Getting lost can not only greatly delay the delivery of one particular pizza; but additionally, all other orders concurrently carried for delivery in adjoining neighborhoods are also delayed, and subsequently received cold. A method of more expeditiously locating a delivery location is needed.

Recipients of medical services are also be concerned with expeditious receipt of those services, particularly in situations which may be in response to an emergency. Such recipients may be hearing impaired or otherwise unable to assist in the receipt of the delivered services. An especially loud or visual signal would attune them to the delivery of those services.

### OBJECTS OF THE INVENTION

It is an object of this invention to disclose a method of expediting delivery of services to residential service recipients at varying residential locations. It is an object of this invention to facilitate more efficient and timely deliveries to varying residential locations. It is yet a further object of this invention to, through the use of an inexpensive apparatus, to illuminate service locations, and prompt residents to prepare for and await the imminent appearance of delivery service personnel. It is yet a further object of this invention to disclose a method and apparatus which will facilitate faster, and more efficient deliveries to the location of a residential service recipient. It is believed that such a method would be particularly appreciated and suitable to ensure the expeditious delivery of hot food.

One aspect of this invention provides for a method of expediting delivery service to residence target locations comprising the steps of: providing an illuminated sign having a delivering service company's indicia thereon; and, positioning the illuminated sign on an interior side of a front window glass at one of the target delivery locations. This method would allow delivery personnel to readily perceive the sign and thereby positively and expeditiously identify the target delivery location.

A preferred aspect of this method further comprises the step of providing a remotely controlled activator and alarm within the illuminated sign so that the illuminated sign would additionally flash and sound an alarm when the remotely controlled activator was activated by delivery personnel entering the proximate area of the sign. The flashing would make the sign more recognizable to delivery personnel, and the alarm would indicate to the recipients within the residential delivery location that a delivery was imminent.

Various other objects, advantages and features of this invention will become apparent to those skilled in the art from the following description in conjunction with the accompanying drawings.

### FIGURES OF THE INVENTION

FIG. 1 is a perspective view of an illuminated sign suitable for hanging in the front window of a service delivery location.

FIG. 2 is a cross sectional schematic view taken along line 2-2 of FIG. 1.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

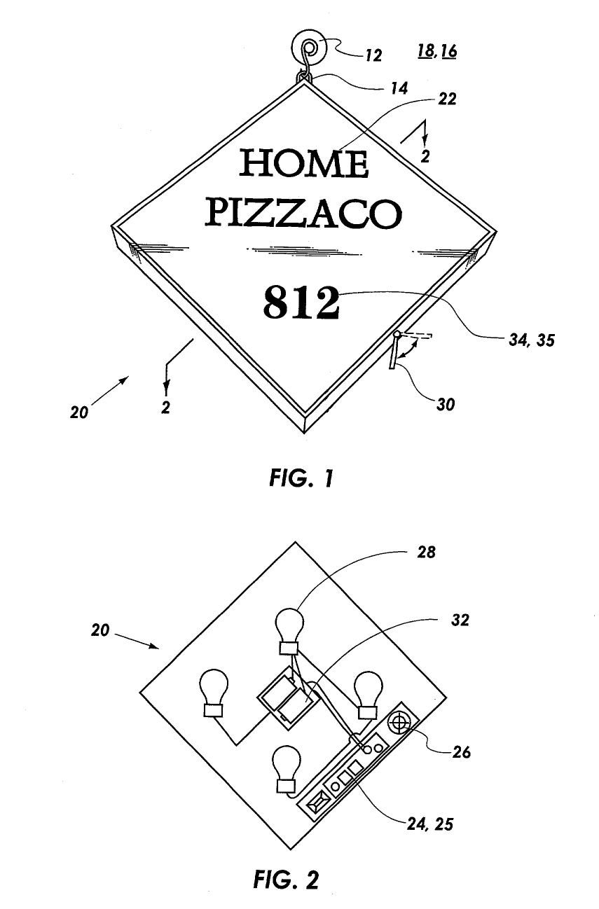

Turning now to the drawings and more particularly to FIG. 1 we have a perspective view of an illuminated sign 20 suitable for hanging in the front window 18 of a service delivery location 16. Most generally, a method of expediting delivery service to residential target delivery locations comprises the steps of: providing an illuminated sign 20 having a delivering service company's indicia 22 thereon; and, positioning the illuminated sign 20 on an interior side of a front window glass 18 at one of the target delivery locations 16. Through fast perception of the illuminated sign 20, delivery personnel could readily, positively, and expeditiously identify the target delivery location 16.

FIG. 2 is a cross sectional schematic view taken along line 2-2 of FIG. 1. FIG. 2 shows the internal composition of the illuminated sign 20. In a preferred embodiment of the invention, the above method further comprises the step of providing a remotely controlled activator 24 and alarm 26 within the illuminated sign 20 so that the illuminated sign 20 would additionally sound an alarm 26 when the remotely controlled activator 24 was activated by delivery personnel entering the proximate area of the sign 20. The alarm 26 would indicate within the residential delivery location 16 that a delivery was imminent. This would give the service recipients additional time to prepare to meet the service delivery personnel; and thereby minimize the delivery personnel's waiting time upon arrival.

In another preferred embodiment of the invention, the further step of providing a lamp flasher 25 within the illuminated sign 20 is contemplated. A lamp flasher 25 causes the lamps 28 within the illuminated sign 20 to alternatively flash on and off when delivery personnel enter the area which is proximate to the illuminated sign. The flashing lamps 28 would indicate to the delivery service personnel that a contact had been facilitated. An electrical switch 30 on the exterior of the illuminated sign 20 could be used to switch power on and off to the sign 20. It is contemplated that such switch 30 would either comprise a toggle or pull chain. Most probably, the illuminated sign 20 would be powered by a battery 32 within the sign 20. Customers would most likely be reminded to switch on the illuminated signs 20 at the time of ordering.

In the most preferred embodiment of the invention, the front portion of the sign 20 would be colored similarly to the delivery company's logo colors. The colors would then increase recognizability of the sign 20 by delivery personnel, and additionally better provide an advertisement for the delivery services company.

In the most preferred embodiment of the invention a front portion of the sign has a reserved portion thereon for a street number 34. The method further comprises the step of adhering self-adhering numerals 35 to an exterior side of the reserved front portion of the sign 20 to provide positive identification of the correct delivery location 16 to delivery personnel. It is contemplated that illuminated signs 20 could be provided to customers as a promotional item for use with subsequent orders.

It is contemplated that the illuminated sign 20 could be fabricated from two sheets of clear plastic each about 10″ square. The sign could be hung from a loop 14 attached to the sign 20 by a suction cup 12 on the interior side of a front window 18. Like the front side portion, the rear side portion of the sign 20 could light up when the remotely controlled activator 24 was activated. The rear side portion could display a message such as “YOUR PIZZA IS HERE”. Such a message would be particularly advantageous to the hearing impaired.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

While the invention has been described with preferred specific embodiments thereof, it will be understood that this description is intended to illustrate and not to limit the scope of the invention, which is defined by the following claims.

I claim:

1) A method of expediting delivery service to residence target locations comprises the steps of:
providing an illuminated sign having a delivering service company's indicia thereon; and,
positioning the illuminated sign on an interior side of a front window glass at one of the target delivery locations;
so that delivery personnel can readily perceive the sign and thereby positively and expeditiously identify the target delivery location.

2) A method as in claim 1 further comprising the step of providing a remotely controlled activator and alarm within the illuminated sign so that the illuminated sign would additionally sound an alarm when the remotely controlled activator was activated by delivery personnel entering the proximate area of the sign, thereby indicating within the residential delivery location that a delivery was imminent.

3) A method as in claim 2 further comprising the step of providing a lamp flasher within the illuminated sign which causes the lamps therein to alternatively flash on and off when delivery personnel entered an area proximate to the illuminated sign, thereby indicating to delivery service personnel that a contact had been facilitated.

4) A method as in claim 1 further comprising the step of providing an electrical switch on the exterior of the illuminated sign which switches power on and off to the sign.

5) A method as in claim 1 wherein the illuminated sign is powered by a battery within the sign.

6) A method as in claim 1 wherein a front portion of the sign is colored similarly to and illuminates the delivery company's logo colors, to thereby increase recognizability to delivery personnel and better provide an advertisement for the delivery services company.

7) A method as in 6 wherein the illuminated sign has a front illuminated display portion and wherein a house number is adhered to the outside of the front illuminated display portion of the sign with plastic self adhering numerals to further provide positive identification of the correct delivery location to delivery personnel.

8) A method as in claim 7 further comprising the step of providing illuminated signs to customers for use with subsequent orders.

9) A method as in claim 8 further comprising the step of reminding customers to switch on the illuminated signs when orders were placed.
